(19) United States
(12) Patent Application Publication
(10) Pub. No.: US 2006/0094811 A1
(43) Pub. Date: May 4, 2006

(54) Nanocomposite composition having barrier property

(76) Inventors: Myung Ho Kim, Daejeon-city (KR); Minki Kim, Daejeon-city (KR); Sehyun Kim, Daejeon-city (KR); Youngtock Oh, Daejeon-city (KR); Jaeyong Shin, Daejeon-city (KR); Youngchul Yang, Daejeon-city (KR)

Correspondence Address: CANTOR COLBURN, LLP, 55 GRIFFIN ROAD SOUTH, BLOOMFIELD, CT, 06002, US

(21) Appl. No.: 11/254,932

(22) Filed: Oct. 20, 2005

(30) Foreign Application Priority Data
Nov. 1, 2004 (KR) 10-2004-0087924
Jun. 2, 2005 (KR) 10-2005-0047120

(51) Int. Cl. C08K 3/34

(52) U.S. Cl. 524/445

(57) ABSTRACT

A dry-blended nanocomposite composition including a resin having a barrier property/intercalated clay nanocomposite and a polyethylene terephthalate resin is provided. The composition has superior mechanical strength and moldability, and superior oxygen, organic solvent, and moisture barrier properties, and thus can be used to manufacture various articles having a barrier property.

### CROSS-REFERENCE TO RELATED PATENT APPLICATION

This application claims the benefit of Korean Patent Application No. 10-2004-0087924, filed on Nov. 1, 2004, and Korean Patent Application No. 10-2005-0047120, filed on Jun. 2, 2005, in the Korean Intellectual Property Office, the disclosures of which are incorporated herein in their entirety by reference.

### BACKGROUND OF THE INVENTION

1. Field of the Invention

The present invention relates to a composition formed by dry-blending a polyethylene terephthalate resin and a nanocomposite of an intercalated clay and a resin having a barrier property.

2. Description of the Related Art

General-purpose resins, such as polyethylene and polypropylene, are used in many fields due to their superior moldability, mechanical properties, and moisture barrier properties. They are limited in their use in packaging or containers for agrochemicals and foods, which require superior chemical and oxygen barrier properties. Therefore, these resins are used in a multi-layer form with other resins via co-extrusion, lamination or coating.

An ethylene-vinyl alcohol (EVOH) copolymer and polyamide are used in multi-layer plastic products due to their high transparency and superior gas barrier properties. Because these resins are more expensive than general-purpose resins, there has been demand for a resin composition capable of obtaining superior barrier properties even when small amounts of these resins are used.

Polyethyleneterephthalate (PET) is a kind of saturated polyester and has a superior mechanical property which is a major characteristic of engineering plastics, and superior surface gloss, resistance to heat, resistance to oil and resistance to solvent. However, PET has a poorer moisture barrier property than polyolefin, and thus is not used in containers for agrochemicals and medicines.

Meanwhile, when a nano-sized intercalated clay is mixed with a polymer matrix to form a fully exfoliated, partially exfoliated, intercalated or partially intercalated nanocomposite, it has an improved barrier property due to its morphology. Thus, an article having a barrier property manufactured using such a nanocomposite is emerging.

It is very important that the nanocomposite maintains its morphology having a barrier property even after being molded.

### SUMMARY OF THE INVENTION

The present invention provides a nanocomposite composition having superior mechanical strength and UV stability, and superior gas, organic solvent, and moisture barrier properties, and capable of maintaining the morphology of a nanocomposite having a barrier property even after being molded.

The present invention also provides an article manufactured by molding the nanocomposite composition having a barrier property.

According to an aspect of the present invention, there is provided a dry-blended nanocomposite composition including: 40 to 97 parts by weight of a polyethylene terephthalate resin (PET); and 3 to 60 parts by weight of at least one nanocomposite having a barrier property, selected from the group consisting of an ethylene-vinyl alcohol (EVOH) copolymer/intercalated clay nanocomposite, a polyamide/intercalated clay nanocomposite, an ionomer/intercalated clay nanocomposite and a polyvinylalcohol/intercalated clay nanocomposite.

The weight ratio of the resin having a barrier property to the intercalated clay in the nanocomposite is 58.0:42.0 to 99.9:0.1, and preferably 85.0:15.0 to 99.0:1.0. If the weight ratio of the resin having a barrier property to the intercalated clay is less than 58.0:42.0, the intercalated clay agglomerates and dispersing is difficult. If the weight ratio of the resin having a barrier property to the intercalated clay is greater than 99.9:0.1, the improvement in the barrier property is negligible.

In an embodiment of the present invention, the PET may be prepared with terephthalic acid as a dicarboxylic acid component and ethylene glycol as a dihydroxy component using esterification (or transesterification) and liquid state polycondensation or solid state polymerization.

In another embodiment of the present invention, the intercalated clay may be at least one material selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

In another embodiment of the present invention, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

In another embodiment of the present invention, the ionomer may have a melt index of 0.1 to 10 g/10 min (190° C., 2,160 g).

According to another aspect of the present invention, there is provided an article manufactured by molding the nanocomposite composition.

In an embodiment of the present invention, the article may be a container, film, pipe, or sheet.

### DETAILED DESCRIPTION OF THE INVENTION

The present invention will now be explained in more detail.

A dry-blended nanocomposite composition having a barrier property according to an embodiment of the present invention include: 40 to 97 parts by weight of a polyethylene terephthalate resin (PET); and 3 to 60 parts by weight of at least one nanocomposite having a barrier property, selected from the group consisting of an ethylene-vinyl alcohol (EVOH) copolymer/intercalated clay nanocomposite, a polyamide/intercalated clay nanocomposite, an ionomer/intercalated clay nanocomposite and a polyvinylalcohol/intercalated clay nanocomposite.

The PET is preferably prepared through solid state polymerization and has an inherent viscosity (I.V.) of about 0.6-1.0 when measured in a concentration of 0.5 g per 25 mL of a mixed solution of phenol and tetrachloroethanol (60/40) at 25° C. The content of the PET is preferably 40 to 95 parts by weight, and more preferably 70 to 90 parts by weight. If the content of the PET is less than 40 parts by weight, molding is difficult. If the content of the PET is greater than 95 parts by weight, the barrier property is poor.

When the PET is used in a continuous phase, the molding process of the composition is simplified, the mechanical strength of a molded article is increased, and costs are reduced.

The nanocomposite can be prepared by blending an intercalated clay and at least one resin having a barrier property selected from the group consisting of an EVOH copolymer, a polyamide, an ionomer and a polyvinyl alcohol (PVA).

The intercalated clay is preferably an organic intercalated clay. The content of an organic material in the intercalated clay is preferably 1 to 45 wt %. When the content of the organic material is less than 1 wt %, the compatibility of the intercalated clay and the resin having a barrier property is poor. When the content of the organic material is greater than 45 wt %, the intercalation of the resin having a barrier property is difficult.

The organic material has at least one functional group selected from the group consisting of from primary ammonmnium to quaternary ammonium, phosphonium, maleate, succinate, acrylate, benzylic hydrogen, oxazoline, and dimethyidistearylammonium.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from primary ammonium to quaternary ammonium, phosphonium, maleate, succinate, acrylate, benzylic hydrogen, dimethyidistearylammonium, and oxazoline.

If an ethylene-vinyl alcohol copolymer is included in the nanocomposite, the content of ethylene in the ethylene-vinyl alcohol copolymer is preferably 10 to 50 mol %. If the content of ethylene is less than 10 mol %, melt molding becomes difficult due to poor processability. If the content of ethylene exceeds 50 mol %, oxygen and liquid barrier properties are insufficient.

If polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 3 to 60 parts by weight, and more preferably 4 to 30 parts by weight. If the content of the nanocomposite is less than 3 part by weight, an improvement of a barrier property is negligible. If the content of the nanocomposite is greater than 60 parts by weight, processing is difficult.

When the intercalated clay is more finely exfoliated in the resin having a barrier property, the nanocomposite can exhibit a better barrier effect. The intercalated clay finely exfoliated in the resin forms a barrier film, which improves the barrier property and mechanical property of the resin and ultimately improves the barrier property and mechanical property of the nanocomposite composition. Thus, in the present invention, the resin having a barrier property and the intercalated clay are blended to disperse a nano-sized intercalated clay in the resin, thereby maximizing a contact area of the resin and the intercalated clay to prevent permeation of gas and liquid.

The nanocomposite composition of the present invention is prepared by dry-blending the resin/intercalated clay nanocomposite having a barrier property in a pellet form and the PET at a constant compositional ratio in a pellet mixer.

Then, the prepared nanocomposite composition is pelletized and molded to obtain an article having a barrier property. The molded article may be obtained by a general molding method including blowing molding, extrusion molding, pressure molding and injection molding.

The article having a barrier property may be a container, sheet, film, or pipe.

Hereinafter, the present invention is described in more detail through examples. The following examples are meant only to increase understanding of the present invention, and are not meant to limit the scope of the invention.

### EXAMPLES

The materials used in the following examples are as follows:

EVOH: E105B (Kuraray, Japan)

Nylon 6: EN 300 (KP Chemicals)

PET: Prepared so as to have an I.V. of about 0.82 through solid state polymerization

Clay: Closite 30B (SCP)

Thermal stabilizer: IR 1098 (Songwon Inc.)

### Preparation Example 1

(Preparation of EVOH/Intercalated Clay Nanocomposite)

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; φ40). Then, 3 wt % of organic montmorillonite (Southern Intercalated Clay Products, USA; Closite 2OA) as an intercalated clay and 0.1 part by weight of IR 1098 as a thermal stabilizer based on total 100 parts by weight of the EVOH copolymer and the organic montmorillonite were separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 30 kg/hr.

### Preparation Example 2

(Preparation of Nylon 6/Intercalated Clay Nanocomposite)

97 wt % of a polyamide (nylon 6, EN300) was put in the main hopper of a twin screw extruder (SM Platek co-rotation twin screw extruder; φ40) . Then, 3 wt % of organic montmorillonite as an intercalated clay and 0.1 part by weight of IR 1098 as a thermal stabilizer based on total 100 parts by weight of the polyamide and the organic montmorillonite were separately put in the side feeder of the twin screw extruder to prepare a nylon 6/intercalated clay nanocomposite in a pellet form. The extrusion temperature condition was 220-225-245-245-245-245-245° C., the screws were rotated at 300 rpm, and the discharge condition was 40 kg/hr.

### Example 1

20 parts by weight of the EVOH nanocomposite prepared in the Preparation Example 1 and 80 parts by weight of a PET prepared so as to have an I.V. of 0.82 through solid state polymerization were dry-blended in a double cone mixer (MYDCM-100, MYEONG WOO MICRON SYSTEM) for 30 minutes. Then, the dry blend was put in a main hopper of injection molding machine (SB III-1000, AOKI, Japan) to prepare a preform. At an injection temperature of 275° C., the preform was injection molded to manufacture a 1000 mL container having a barrier property.

### Example 2

20 parts by weight of the Nylon 6 nanocomposite prepared in the Preparation Example 2 and 80 parts by weight of a PET prepared so as to have an I.V. of 0.82 through solid state polymerization were dry-blended in a double cone mixer (MYDCM-100, MYEONG WOO MICRON SYSTEM) for 30 minutes. Then, the dry blend was put in a main hopper of injection molding machine (SB III-1000, AOKI, Japan) to prepare a preform. At an injection temperature of 275° C., the preform was injection molded to manufacture a 1000 mL container having a barrier property.

### Example 3

4 parts by weight of the Nylon 6 nanocomposite prepared in the Preparation Example 2 and 96 parts by weight of a PET prepared so as to have an I.V. of 0.82 through solid state polymerization were dry-blended in a double cone mixer (MYDCM-100, MYEONG WOO MICRON SYSTEM) for 30 minutes. Then, the dry blend was put in a main hopper of injection molding machine (SB III-1000, AOKI, Japan) to prepare a preform. At an injection temperature of 275° C., the preform was injection molded to manufacture a 1000 mL container having a barrier property.

### Example 4

45 parts by weight of the Nylon 6 nanocomposite prepared in the Preparation Example 2 and 55 parts by weight of a PET prepared so as to have an I.V. of 0.82 through solid state polymerization were dry-blended in a double cone mixer (MYDCM-100, MYEONG WOO MICRON SYSTEM) for 30 minutes. Then, the dry blend was put in a main hopper of injection molding machine (SB III-1000, AOKI, Japan) to prepare a preform. At an injection temperature of 275° C., the preform was injection molded to manufacture a 1000 mL container having a barrier property.

### Example 5

45 parts by weight of the Nylon 6 nanocomposite prepared in the Preparation Example 2 and 55 parts by weight of a PET prepared so as to have an I.V. of 0.82 through solid state polymerization were put in a main hopper of injection molding machine (SB III-1000, AOKI, Japan) through belt-type feeders K-TRON Nos. 1 and 2, respectively, in a dry-blend state to prepare a preform. At an injection temperature of 275° C., the preform was injection molded to manufacture a 1000 mL container having a barrier property.

### Comparative Example 1

A container having a barrier property was manufactured in the same manner as in Example 1, except that EVOH was used instead of the EVOH nanocomposite.

### Comparative Example 2

A container having a barrier property was manufactured in the same manner as in Example 2, except that nylon 6 was used instead of the Nylon 6 nanocomposite.

### Comparative Example 3

PET prepared so as to have an I.V. of 0.82 through solid state polymerization was dried at 170° C. and put in an injection molding machine to prepare a preform. The preform was injection molded to manufacture a 1000 mL container.

### Experimental Example

1) Liquid Barrier Property

Toluene, Desys herbicide (1% of deltametrine+emulsifier, stabilizer, and solvent; Kyung Nong), Batsa insecticide (50% of BPMC+50% of emulsifier and solvent), and water were put in the containers manufactured in Examples 1 to 5 and Comparative Examples 1 to 3. Then, the weight change was determined after 30 days under a condition of forced exhaust at 50° C. For toluene, the weight change was further determined at room temperature (25° C.).

2) Gas Barrier Property (cc/m², day, atm)

The containers manufactured in Examples 1 to 5 and Comparative Examples 1 to 3 were left alone under a temperature of 23° C. and a relative humidity of 50% for 1 day. Then, the gas penetration rate was determined (Mocon OX-TRAN 2/20, U.S.A).

TABLE 1
Gas barrier property

| | Oxygen | Moisture |
|---|---|---|
| | (cm²/m² · 24 hrs · atm) | (g/m² · 24 hrs) |
| Example 1 | 61.5 | 1.14 |
| Example 2 | 48.9 | 1.31 |
| Example 3 | 96.3 | 1.02 |
| Example 4 | 30.7 | 1.47 |
| Example 5 | 31.8 | 1.51 |
| Comparative Example 1 | 109.8 | 2.11 |
| Comparative Example 2 | 112.3 | 2.26 |
| Comparative Example 3 | 124.6 | 2.37 |

TABLE 2
Liquid barrier property

| | Liquid barrier property (%) | | | | |
|---|---|---|---|---|---|
| | Weight change | | | | |
| | at 25° C. | Weight change at 50° C. | | | |
| | Toluene | Toluene | Desys | Batsa | Water |
| Example 1 | 0.07 | 1.02 | 0.53 | 0.32 | 0.0024 |
| Example 2 | 0.11 | 1.17 | 0.84 | 0.23 | 0.0019 |
| Example 3 | 0.28 | 2.07 | 1.73 | 0.58 | 0.0017 |
| Example 4 | 0.06 | 0.53 | 0.49 | 0.13 | 0.0035 |
| Example 5 | 0.07 | 0.62 | 0.59 | 0.16 | 0.0037 |
| Comparative | 0.33 | 2.40 | 1.77 | 0.57 | 0.0039 |
| Example 1 | | | | | |
| Comparative | 0.32 | 2.30 | 1.75 | 0.55 | 0.0054 |
| Example 2 | | | | | |
| Comparative | 0.35 | 2.41 | 1.88 | 0.57 | 0.0053 |
| Example 3 | | | | | |

As shown in Tables 1 and 2, containers of Examples 1 to 5 have a superior gas and liquid barrier property compared to those of Comparative Examples 1 to 3.

The nanocomposite composition according to an embodiment of the present invention has superior mechanical strength, and superior oxygen, organic solvent, and moisture barrier properties.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A dry-blended nanocomposite composition comprising:
40 to 97 parts by weight of a polyethylene terephthalate resin; and
3 to 60 parts by weight of at least one nanocomposite having a barrier property, selected from the group consisting of an ethylene-vinyl alcohol copolymer/intercalated clay nanocomposite, a polyamide/intercalated clay nanocomposite, an ionomer/intercalated clay nanocomposite and a polyvinylalcohol/intercalated clay nanocomposite.

2. The composition of claim 1, wherein the polyethylene terephthalate resin is prepared through solid state polymerization and has an inherent viscosity (I.V.) of about 0.6-1.0.

3. The composition of claim 1, wherein the intercalated clay is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

4. The composition of claim 1, wherein the intercalated clay comprises 1 to 45 wt % of an organic material.

5. The composition of claim 4, wherein the organic material has at least one functional group selected from the group consisting of from primary ammonmnium to quaternary ammonium, phosphonium, maleate, succinate, acrylate, benzylic hydrogen, oxazoline, and dimethyldistearylammonium.

6. The composition of claim 1, wherein the ethylene-vinyl alcohol copolymer contains 10 to 50 mol % of ethylene.

7. The composition of claim 1, wherein the polyamide is nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

8. The composition of claim 1, wherein the ionomer has a melt index of 0.1 to 10 g/10 min (190° C., 2,160 g).

9. The composition of claim 1, wherein the weight ratio of the resin having a barrier property to the intercalated clay in the nanocomposite is 58.0:42.0 to 99.9:0.1.

10. An article manufactured by molding the nanocomposite composition of claim 1.

11. The article of claim 10, being a container, film, pipe, or sheet.

12. The article of claim 10, manufactured through blow molding, extrusion molding, pressure molding, or injection molding.
